(19) United States
(12) Patent Application Publication
(10) Pub. No.: US 2011/0012552 A1
(43) Pub. Date: Jan. 20, 2011

(54) Electrical power source

(76) Inventor: Erez Margalit, Pasadena, CA (US)

Correspondence Address: VOLERE, INC / EREZ MARGALIT, PRESIDENT, 556 S. FAIR OAKS AVE., #10, PASADENA, CA, 91105, US

(21) Appl. No.: 12/798,537

(22) Filed: Apr. 5, 2010

Related U.S. Application Data
(63) Continuation of application No. PCT/US2008/011527, filed on Oct. 5, 2008.
(60) Provisional application No. 60/997,821, filed on Oct. 5, 2007.

(51) Int. Cl. H02J 7/00; H01M 12/02

(52) U.S. Cl. 320/101; 429/9

(57) ABSTRACT

A portable power supply coupled to a garment, carrying bag, or other apparatus, is adapted for receiving energy at a solar cell or by way of a power input port for operating and charging a portable device. Power is stored within the power supply in one or more batteries or other storage devices. An output of the portable power supply is adapted to be reconfigured so as to be coupled to various types of portable device.

### CROSS-REFERENCE TO RELATED APPLICATIONS

The present application is a continuation of International Application No.: PCT/US 2008/011527 filed on Oct. 5, 2008, which in turn claims the benefit of U.S. Provisional Patent Application No. 60/997,821 filed on Oct. 5, 2007, the disclosures of both being incorporated herewith by reference in their entireties.

### FIELD OF THE INVENTION

The present invention relates to a power supply, and more particularly to a power supply for charging an external storage device.

### BACKGROUND

Small electronic portable appliances such as cellular phones, compact entertainment devices, hand held “palm” computers, GPS navigation devices, and small wireless communication equipment have become extremely popular with people of all ages, genders, and locations.

Generally these devices use electrical power to operate. As portable devices they are not connected to the power utility outlets, but instead use batteries as a power source. An ever increasing percentage of these appliances use rechargeable batteries or other rechargeable storage devices. Unlike regular batteries which are replaced with new batteries when they run out of power, while the used batteries are disposed of, rechargeable batteries can be recharged from an external power source, again and again, and need not be replaced.

Recharging of portable appliances is typically done by connecting such portable appliances to a power supply which is, in turn, connected to a residential power utility or to an automotive power outlet so as to receive power for the rechargeable batteries. These power sources are not portable and, therefore, while the batteries of the small portable appliances are being recharged the appliances are stationary and not portable. On the other hand if the batteries of the small portable appliances are not recharged periodically, they run out of charge. This renders the portable appliances useless.

### SUMMARY OF THE INVENTION

To make such small portable appliances really portable and usable everywhere without a need to recharge the batteries of these portable appliances from the power utilities or automotive power outlets, the inventor is harnessing the power of the sun.

In daily life many people carry handbags and backpacks in which they store and carry personal items such as money, documents, books, cosmetics items, and small portable electronic appliances.

According to this invention, carrying apparatus such as personal backpacks and handbags are fitted with a photovoltaic device such as a solar panel to convert solar energy into electrical power to operate a special battery charging apparatus capable of charging the batteries of portable electronic appliances. This enables such a backpack or handbag to simultaneously charge and use the small portable appliances while carried around wherever the user carries the backpack or handbag. In certain embodiments, the photovoltaic cell electrical power source includes a photovoltaic cell; a low light detector; an output switch; a detector comparator; a reconfigurable switch and two or more rechargeable batteries. The batteries are adapted to be alternately connected in series and parallel according to a condition of the reconfigurable switch. The power source has, in certain embodiments, an output including two wires terminating at a connector. In certain embodiments, the photovoltaic device and power supply are supported by and/or integral with a carrying apparatus.

### BRIEF DESCRIPTION OF THE DRAWINGS

FIG. 1 shows, in block diagram form, a portion of a power supply according to one embodiment of the invention;

FIG. 2 shows, in block diagram form, an exemplary adapter device according to one embodiment of the invention; and

FIG. 3 shows, in perspective view, a carrying case including a photovoltaic device and device under charge, forming a system according to one embodiment of the invention.

### DETAILED DESCRIPTION

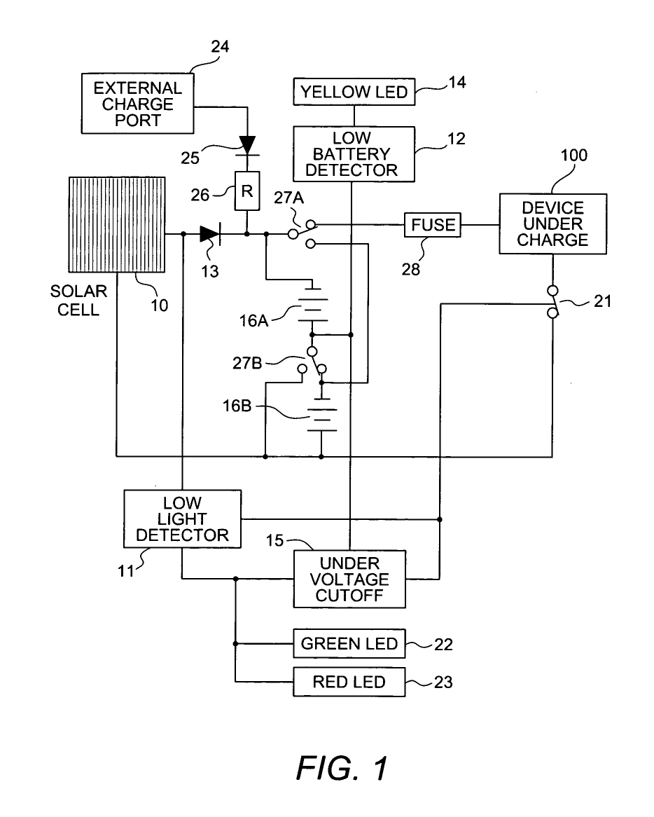

The present invention is to be understood with reference to FIGS. 1, 2 and 3. As illustrated, a photovoltaic (solar) cell 10 connects to rechargeable batteries 16A and 16B via a diode 13. One of skill in the art will appreciate that other rechargeable devices such as, for example, a capacitive charge storage device, can also be employed in the present invention. When the solar cell 10 is exposed to light, it generates an electrical current. Due to the internal resistance of the solar cell 10, the electrical current, generated as a result of exposure to light, causes the voltage at the positive output pin of the solar cell 10 to increase above the voltage across the battery 16. Under these conditions, the current generated in the solar cell 10 can flow through the diode 13 to charge the battery 16 (16A and 16B).

The voltage across the battery 16 is a property of the chemistry of the battery and the charge in the battery. The chemistry determines the nominal voltage on the battery while the charge in the battery can change the voltage across the battery by as much as 20%. For example, the typical nominal voltage on a Nickel Cadmium battery is 1.2V, but it may be as low as 1.15V when the battery is discharged, and as high as 1.4V when such battery is fully charged.

When a voltage higher than the nominal voltage of a battery is desired, two or more batteries can be connected in series to yield an overall voltage which is the nominal voltage multiplied by the number of batteries connected in series.

The charger 200 is designed to continuously charge the portable electronic appliance 100 connected to the charger 200. However, charging the appliance 100 when intensity of the light to which the solar cell 10 is exposed is too low, may deplete the battery 16 of its charge, causing improper operation of the charger 200. Two circuits are used here to prevent the battery from being over discharged. One is such that when the solar cell 10 output is insufficient to charge the battery 16, the low light detection comparator 11 will control the output switch 21 to the OFF state, which will disconnect the charge current to the external appliance 100. One of skill in the art will appreciate that output switch 21 will, in certain embodiments, be implemented as a solid-state switching device such as, for example, a transistor. Consequently, when the light onto the solar panel 10 is of sufficient intensity to overcome the predetermined set-point voltage at the comparator input 11, the comparator 11 will change its state, and the output switch 21 will again be controlled to the ON state, completing the circuit and enabling the charge current to the external appliance 100. A green LED 22 will serve to indicate that the charger 200 has sufficient charge and is currently capable of charging an external appliance 100. The other circuit section consists of the battery under-voltage detector 15. This circuit's function is to prevent the over-discharge of the battery 16. Over discharging can be harmful to the longevity of the battery 16, if the battery remains in this discharged condition for long periods. This circuit monitors the voltage at the battery 16. If the voltage across the battery 16 falls below the preset low level threshold voltage, in this case, the detector/comparator 15 will control the output switch 21 to the OFF state, subsequently disconnecting the external appliance 100. A red LED 23, connected to the under-voltage detector 15, when illuminated, will serve to indicate that the battery 16, has reached a predetermined low level, and now the charger 200 is not currently capable of charging an external appliance 100. When the battery 16 voltage is again of sufficient level to reset the state of the comparator 15, the output of the comparator 15 will control the output switch 21 to its ON state, thereby allowing the charger to charge the external appliance 100. Consequently, the green LED 22, connected to the output of the detector 15, will illuminate to indicate that the battery 16 has been sufficiently charged and the charger 200 is now capable of charging an external appliance 100.

The low battery detector circuit 12 alerts the user as to the state of the battery 16 charge. When the battery 16 voltage falls below a predetermined set-point, the low battery detection circuit 12 will change state, and will cause to illuminate a yellow LED 14. When illuminated, this will serve to alert the user as to the approaching discharged condition of the battery 16, and the user can then take the necessary action to recharge the battery 16.

When the solar cell 10 is exposed to sufficient intensity of light, the voltage generated by the solar cell 10 is no longer lower than that of the battery 16, and the under voltage detector 15 turns ON controlling the output switch 21 to ON state. Consequently, the green LED 22, connected to the output of the detector 15, will illuminate to indicate that the charger 200 is now capable of charging an external appliance 100.

External charge port 24 allows for supplemental charging of charger 200 from other sources when sunlight is unavailable, such as at night or when indoors under low light conditions. The charge port 24 consists of a USB mini-B connector that is compatible with industry standard USB format. Using an appropriate cable, the charger 200 can be charged via any personal computer that is equipped with a USB port. Charging can also be applied to this port 24 with any wall transformer type appliance that is specifically designed for this purpose. Current from the USB connector input source is coupled to the battery 16 through diode 25 and current limiting resistor 26.

Switch 27 is used to select the appropriate charge source to the battery 16. In position 1, the switch 27 will configure the battery(s) 16 so as to charge in parallel. This allows the battery 16 to charge from the lower voltage of the USB sourced input. This position also serves to disable the operation of the charger 200, while charging the battery 16. Position 2 of switch 27 also has 2 functions. One function is to enable charger 200 operation. The other function is to reconfigure the battery(s) in series so as to have sufficient voltage to charge an external device 100.

The charger 200 output circuit is protected by a resettable fuse 28. If the output of the charger 200 is shorted, or if there is a problem with the external device 100, causing the current from the battery 16 to increase beyond a preset set point, the resettable fuse 28 will be heated causing the resistance of the resettable fuse 28 to increase. This will limit the current from the charger 200 to a safe value, preventing damage to the charger 200, or the external device 100. When the cause of the short, or the external device 100, is disconnected from the output of the charger 200, the resettable fuse 28 will cool, and the resistance of the resettable fuse 28 will decrease to a normal value, allowing the charger 200 to again be ready to charge an external device 100.

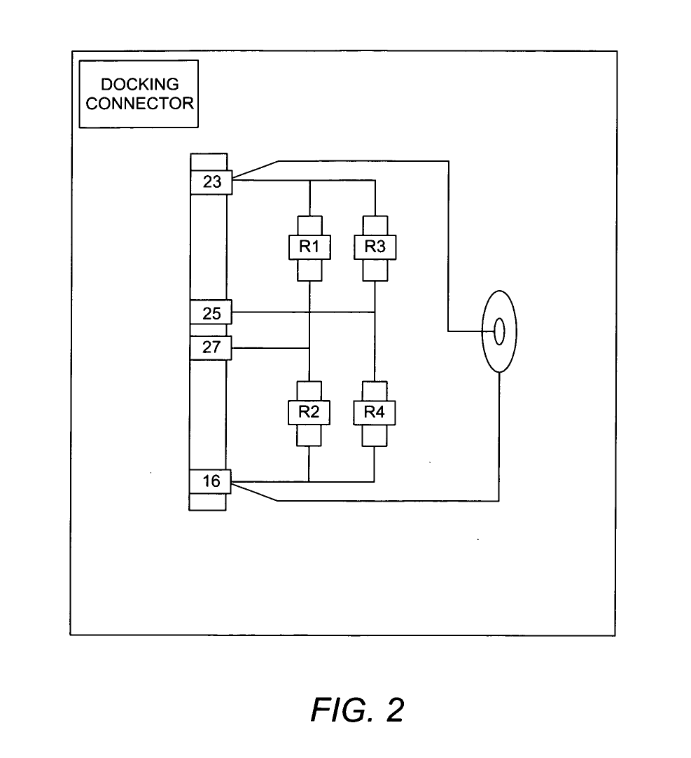

In certain embodiments, the invention includes a kit having a power supply and one or more adapter devices. For example, in one embodiment, the kit includes a first iPhone® adapter and a second iPod® adapter (FIG. 2). By connecting the adapter to the output of the power supply, a custom configuration of the power supply is provided. This configuration allows for the charging of the iPhone® and iPod® from the charger 200. In the illustrated embodiment of FIG. 2, the adapter is internally configured with 4 biasing resistors. These resistors are connected in such a manner so as to apply a low bias voltage to the USB Data (+) and USB Data (−) connections. Power for the biasing is derived from the charger 200 power source connection.

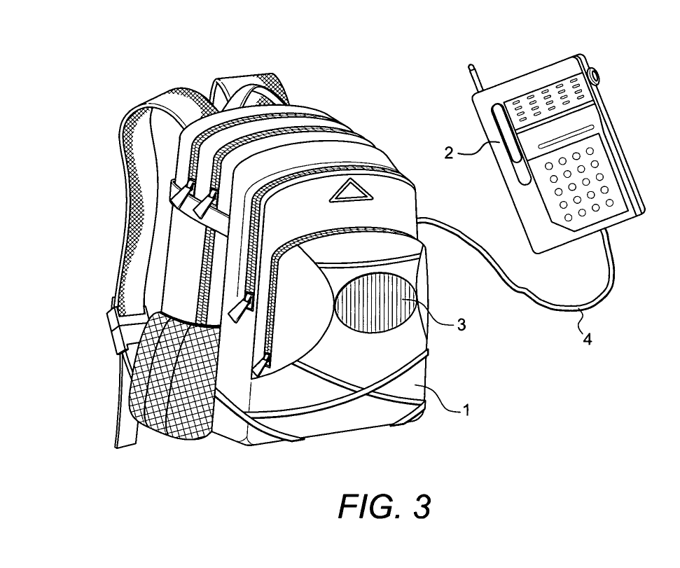

FIG. 3 shows, in perspective view, a charging system including a luggage article according to one embodiment of the invention. In the illustrated embodiment, the luggage article is a backpack 1. A photovoltaic cell 3 is coupled to an external surface of the backpack 1. An electrical conductor 4 is provided to convey power from a power supply to a portable device 2. The power supply is disposed within the backpack and coupled to both the photovoltaic cell 3 and electrical conductor 4.

While reference is made in the above examples to batteries such as, for example, electrochemical batteries, one of skill in the art will appreciate that the invention may, according to its principles, be applied to a wide variety of other energy storage devices including, without limitation, capacitive energy storage devices, pneumatic energy storage devices, and mechanical energy storage devices, according to the requirements of any particular application. In addition, while reference is made to a photovoltaic or solar cell for receiving energy, one of skill in the art will appreciate that alternative devices and means for receiving energy such as, for example, a microwave energy receiver, would also fall within the scope of the invention. Further, one of skill in the art will appreciate that the principles of the invention are equally well applied, and that the benefits of the present invention are equally well realized in a wide variety of other systems. Therefore, while the invention has been described in detail in connection with the presently preferred embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Accordingly, the invention is not to be seen as limited by the foregoing description, but is only limited by the scope of the appended claims.

1. A photovoltaic cell electrical power source comprising:
a photovoltaic cell;
a low light detector;
an output switch;
a detector comparator;
a reconfigurable switch;
two or more rechargeable batteries, the batteries being adapted to be alternately connected in series and parallel according to a condition of said reconfigurable switch, said power source having an output including two wires terminating at a connector; and
a device case.

2. A photovoltaic cell electrical power source as defined in claim 1 further comprising an adapter, said adapter being adapted to couple said connector to a particular rechargeable device.

3. A photovoltaic cell electrical power source, as defined in claim 1 wherein said device case comprises a luggage article and said photovoltaic cell is coupled to an outer surface of said luggage article.

4. A photovoltaic cell electrical power source, as defined in claim 3 wherein electrical power generated by said electrical power source is adapted to charge a rechargeable battery of a portable electronic device.

5. A photovoltaic cell electrical power source, as defined in claim 1 wherein said photovoltaic cell electrical power source is adapted to power a portable electronic entertainment device.

6. A photovoltaic cell electrical power source, as defined in claim 1 wherein said photovoltaic cell powered electrical power source is adapted to power a portable electronic navigational aid device.

7. A photovoltaic cell electrical power source, as defined in claim 1 wherein said device case comprises a garment article and wherein said photovoltaic cell is adapted to be coupled to an outer surface of said garment article.

8. A photovoltaic cell electrical power source, as defined in claim 7 wherein electrical power generated by said electrical power source is adapted to charge a rechargeable battery of a portable device.

9. A photovoltaic cell electrical power source, as defined in claim 1 wherein said photovoltaic cell electrical power source is adapted to power a portable electronic communication device.

10. A photovoltaic cell electrical power source as defined in claim 1 wherein said photovoltaic cell powered electrical power source is connected through a special adaptor to power an Apple® compatible device.

11. A photovoltaic cell electrical power source as defined in claim 10 wherein said Apple® compatible device comprises an iPhone®.

12. A photovoltaic cell electrical power source as defined in claim 10 wherein said Apple® compatible device comprises an iPod®.

13. A photovoltaic cell electrical power source, as defined in claim 1, comprising a low light detector, said low light detector being operatively coupled to an output of said photovoltaic cell.

14. A photovoltaic cell electrical power source, as defined in claim 1 wherein said output switch is adapted to control a flow of charging current to an external device.

15. A photovoltaic cell electrical power source, as defined in claim 1 wherein said output switch comprises an automatic switching device.

16. A photovoltaic cell electrical power source, as defined in claim 1 wherein said output switch comprises a transistor device.

17. A photovoltaic cell electrical power source, as defined in claim 1, in which said low light detector is connected to a control input of said output switch.

18. A photovoltaic cell electrical power source, as defined in claim 1 wherein said low light detector is adapted to render said output switch substantially nonconductive so as to prevent charging of an external device.

19. A photovoltaic cell electrical power source, as defined in claim 1, further comprising an adapter, said adapter being configured for charging an Apple® device with an electrical current supplied by said photovoltaic cell electrical power source.

20. A photovoltaic cell electrical power source, as defined in claim 19 wherein said electrical current comprises a nominal 5 Volt electrical current.

21. A photovoltaic cell electrical power source, as defined in claim 19 wherein said adapter includes a two-terminal input port.

22. A photovoltaic cell electrical power source, as defined in claim 1919 wherein said adapter comprises an Apple® docking connector.

23. A photovoltaic cell electrical power source, as defined in claim 22 wherein power from said solar power source is connected both between a pin 16 and a pin 23 of said docking connector and across a biasing resistor network so as to cause said biasing resistor network to produce a lower biasing voltage of approximately two volts.

24. A photovoltaic cell electrical power source, as defined in claim 19 wherein said adapter comprises four embedded biasing resistors.

25. A photovoltaic cell electrical power source, as defined in claim 24 wherein said four embedded biasing resistors are connected so as to apply respective bias voltages to respective data + and data − connection pins of said docking connector.

26. A photovoltaic cell electrical power source, as defined in claim 1 comprising an adapter, said adapter being configured for charging a USB device with an electrical current supplied by said photovoltaic cell electrical power source.

27. A photovoltaic cell electrical power source, as defined in claim 26 wherein said electrical current is adapted to produce a nominal 5 Volt electrical potential.

28. A photovoltaic cell electrical power source, as defined in claim 26 wherein said adapter includes a two-terminal input port.

29. A photovoltaic cell electrical power source, as defined in claim 1 comprising a detector comparator, said detector comparator being adapted to monitor a voltage of at least one of said batteries.

30. A photovoltaic cell electrical power source, as defined in claim 29 wherein if said detector comparator detects a voltage across said at least one battery below a preset switch off threshold, said detector comparator will control said output switch to an off state so as to disconnect an external appliance.

31. A photovoltaic cell electrical power source, as defined in claim 29 wherein if said detector comparator detects a voltage across said at least one battery above a preset switch on threshold, said detector comparator will control said output switch to an on state so as to connect an external appliance. 29

32. A photovoltaic cell electrical power source, as defined in claim 25 wherein said detector comparator is adapted to have a first switch off threshold and a second switch on threshold.

33. A photovoltaic cell electrical power source, as defined in claim 29 wherein said first switch off threshold is equal to said second switch on threshold.
